(19) United States
(12) Patent Application Publication
(10) Pub. No.: US 2025/0184001 A1
(43) Pub. Date: Jun. 5, 2025

(54) OPTICAL TRANSMISSION APPARATUS AND OPTICAL TRANSMISSION METHOD

(71) Applicant: Fujitsu Limited, Kawasaki-shi (JP)

(72) Inventors: Yusaku YAMAMOTO, Kawasaki (JP); Yoshito KACHITA, Kawasaki (JP)

(73) Assignee: Fujitsu Limited, Kawasaki-shi (JP)

(21) Appl. No.: 18/951,092

(22) Filed: Nov. 18, 2024

(30) Foreign Application Priority Data
Nov. 30, 2023 (JP) 2023-203419

(51) Int. Cl. H04B 10/071; H01S 3/30; H04B 10/079; H04B 10/291; H04B 10/50

(52) U.S. Cl. CPC H04B 10/071; H01S 3/302; H04B 10/0795; H04B 10/2916; H04B 10/503

(57) ABSTRACT

An optical transmission apparatus that performs Raman amplification on WDM light in a transmission line using Raman pumping light, the optical transmission apparatus includes a controller configured to at a time of activation, measure a first reflected light level that is reflected and input from the transmission line when only optical supervisory channel (OSC) light is transmitted to the transmission line, measure a second reflected light level that is reflected and input from the transmission line when the WDM light, the Raman pumping light, and the OSC light are transmitted to the transmission line, calculate a correction value based on the first reflected light level and the second reflected light level, and during operation of the optical transmission apparatus, monitor the input reflected light level and perform auto power shut down (APSD) control based on a reflected light level corrected by the correction value.

### CROSS-REFERENCE TO RELATED APPLICATION

This application is based upon and claims the benefit of priority of the prior Japanese Patent Application No. 2023-203419, filed on Nov. 30, 2023, the entire contents of which are incorporated herein by reference.

### FIELD

The embodiment discussed herein is related to an optical transmission apparatus and an optical transmission method.

### BACKGROUND

There is an optical transmission apparatus that optically amplifies WDM light in a transmission line such as an optical fiber based on Raman pumping light. The optical transmission apparatus has a safety control function of output light cutoff by auto power shut down (APSD), and suppresses a situation in which a laser beam having light power is radiated to an outside and causes harm to a human body. The APSD stops output of an optical amplifier when link-down is detected using optical supervisory channel (OSC) light.

As a related art for monitoring a transmission state of WDM light, for example, there is a technique in which a filter for removing reflected light of Raman pumping light is provided, and residual Raman pumping light mixed in the reflected light is removed by the filter, so that malfunction of a cutoff circuit of an optical amplifier is suppressed by the Raman pumping light. There is a monitoring method in which a position of backscattering and a signal loss of an optical fiber link are determined based on a monitoring signal for monitoring the optical fiber link and a data signal to be transmitted.

Japanese Laid-open Patent Publication No. 2006-324684 and U.S. Patent Application Publication No. 2017/0346550 are disclosed as related art.

### SUMMARY

According to an aspect of the embodiments, an optical transmission apparatus that performs Raman amplification on WDM light in a transmission line using Raman pumping light, the optical transmission apparatus includes a controller configured to at a time of activation of the optical transmission apparatus, measure a first reflected light level that is reflected and input from the transmission line when only optical supervisory channel (OSC) light is transmitted to the transmission line, measure a second reflected light level that is reflected and input from the transmission line when the WDM light, the Raman pumping light, and the OSC light are transmitted to the transmission line, calculate a correction value equivalent to noise light of a reflected light level that is reflected and input from the transmission line, based on the first reflected light level and the second reflected light level, and during operation of the optical transmission apparatus, monitor the input reflected light level and perform auto power shut down (APSD) control based on a reflected light level corrected by the correction value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an optical transmission apparatus according to an embodiment;

FIG. 2 is an explanatory diagram in a normal state according to an existing technique;

FIG. 3 is an activation sequence diagram of an optical transmission apparatus according to the existing technique;

FIG. 4 is an explanatory diagram of an APSD state expected at a time of occurrence of a failure;

FIG. 5 is an explanatory diagram of a problem at a time of multiband transmission according to the existing technique;

FIG. 6 is an explanatory diagram of a factor 1 of noise light occurrence;

FIG. 7 is an explanatory diagram of a factor 2 of the noise light occurrence;

FIG. 8A is an explanatory diagram of correction of a reflection monitor value in the optical transmission apparatus according to the embodiment (part 1);

FIG. 8B is an explanatory diagram of correction of the reflection monitor value in the optical transmission apparatus according to the embodiment (part 2);

FIG. 8C is a chart for describing correction of the reflection monitor value and APSD control according to the embodiment;

FIG. 9 is a functional block diagram of the optical transmission apparatus according to the embodiment;

FIG. 10 is a diagram illustrating a hardware configuration example of a control unit of the optical transmission apparatus according to the embodiment;

FIG. 11 is an activation sequence diagram of the optical transmission apparatus according to the embodiment (in a normal state); and

FIG. 12 is an activation sequence diagram of the optical transmission apparatus according to the embodiment (when fiber characteristics change due to a fiber removal work).

### DESCRIPTION OF EMBODIMENTS

A bandwidth of a WDM transmission system has been expanded in recent years, and for example, a multiband (C+L band) WDM transmission system that transmits WDM light simultaneously using a C-band and an L-band has been proposed. According to the related art, in a case where multiband transmission is performed as it is, a number of wavelengths of the WDM light (main signal) having a gain increases. In this case, due to a factor that noise light in an OSC band that has become a high level due to stimulated Raman scattering (SRS) is reflected and input to a transmission node, or the like, a monitor value of the OSC may be erroneously detected as high reflection. In this case, an APSD function of the transmission node operates, and the WDM light during operation is shut down. WDM is an abbreviation for wavelength division multiplexing, and SRS is an abbreviation for stimulated Raman scattering.

In one aspect, an object of the present disclosure is to suppress malfunction of APSD caused by noise included in OSC light in an optical transmission apparatus that performs Raman pumping.

Hereinafter, an embodiment of the disclosed optical transmission apparatus will be described in detail with reference to the accompanying drawings.

### (Configuration Example of Optical Transmission Apparatus According to Embodiment)

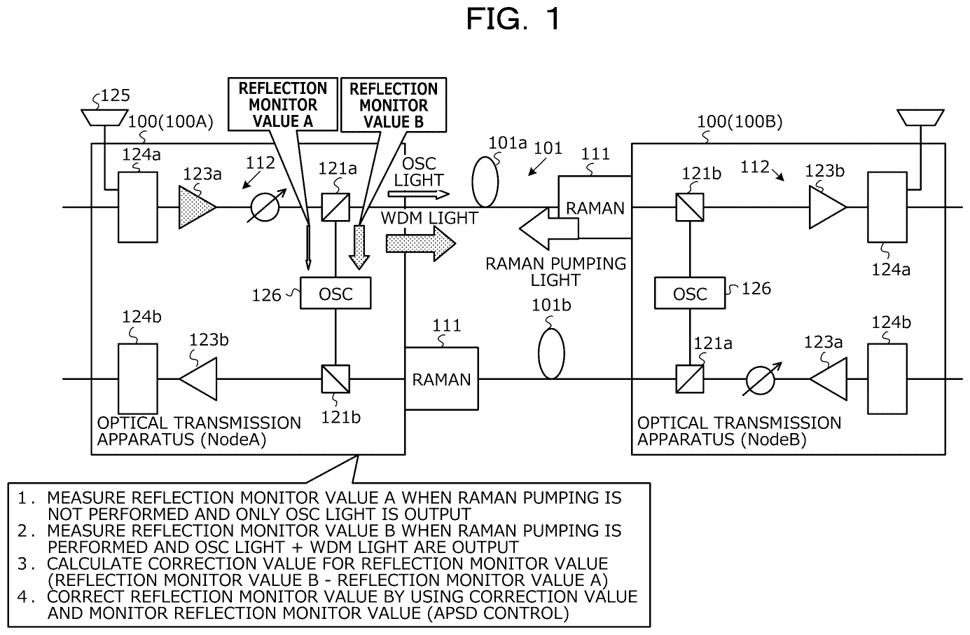

FIG. 1 is an explanatory diagram of an optical transmission apparatus according to an embodiment. According to an example illustrated in FIG. 1, optical transmission apparatuses 100 are disposed in an upstream NodeA and a downstream NodeB with the same configuration respectively, and transmit WDM light (main signal) via a transmission line 101 such as an SMF.

SMF is an abbreviation for single mode optical fiber. For example, the WDM light has a multiband wavelength band of a C-band and an L-band (C+L) in the main signal.

The transmission line 101 includes a downlink transmission line 101a from an optical transmission apparatus 100A of the upstream (NodeA) to an optical transmission apparatus 100B of the downstream (NodeB). The transmission line 101 includes an uplink transmission line 101b from the optical transmission apparatus 100B of the downstream (NodeB) to the optical transmission apparatus 100A of the upstream (NodeA).

A configuration example in a case where the optical transmission apparatus 100A on the upstream (NodeA) of the downlink transmission line 101a is its own station (transmission node) will be described below. The optical transmission apparatus 100A includes a Raman amplifier 111 and a ROADM 112. ROADM is an abbreviation for reconfigurable optical add/drop multiplexer.

The optical transmission apparatus 100A includes the Raman amplifier 111. The Raman amplifier 111 has a Raman pumping light source therein and performs backward Raman pumping on the transmission line 101a by using backward Raman pumping light. The ROADM 112 includes multiplexers/demultiplexers 121, WDM amplifiers (optical amplifiers) 123, wavelength selective switches (WSS) 124, a multiplexer (MUX/DEMUX) 125, and an OSC processing unit 126. WSS is an abbreviation for wavelength selective switch. The OSC processing unit 126 includes a function of transmitting and receiving OSC light.

As viewed along a path of the downlink transmission line 101a, the multiplexer 125 wavelength-multiplexes and demultiplexes WDM light to be input to and output from a WSS 124a. The WSS 124a performs adding and dropping of WDM light having arbitrary wavelength with respect to the transmission line 101a. An optical amplifier 123a optically amplifies the WDM light over the transmission line 101a.

The OSC processing unit 126 causes failure information detected by the optical transmission apparatus 100A to be included in the OSC light. The OSC light is multiplexed with the WDM light in the downlink transmission line 101a via a multiplexer/demultiplexer 121a, and is transmitted to the optical transmission apparatus 100B of the downstream (NodeB).

As viewed along a path of the uplink transmission line 101b, a multiplexer/demultiplexer 121b demultiplexes a wavelength band of OSC light for monitoring from the WDM light over the transmission line 101b and outputs the wavelength band to the OSC processing unit 126. An optical amplifier 123b optically amplifies the WDM light over the transmission line 101b. A WSS 124b performs adding and dropping of WDM light having arbitrary wavelength with respect to the transmission line 101b. For example, EDFAs are used for the optical amplifiers 123a and 123b. EDFA is an abbreviation for erbium doped fiber amplifier.

The optical transmission apparatus 100A performs APSD control based on a state of the OSC light. For example, the downstream optical transmission apparatus 100B transmits OSC light to the optical transmission apparatus 100A via the uplink transmission line 101b when OSC disconnection of the downlink transmission line 101a occurs. Upon receiving the OSC disconnection, the OSC processing unit 126 of the optical transmission apparatus 100A stops the output of the WDM light by APSD of its own station.

In the optical transmission apparatus 100A, in a case where a failure (such as disconnection or opening of a transmission line) occurs in the downlink transmission line 101a, the OSC processing unit 126 detects a state in which reflected light generated in the OSC light has become highly reflective (high level), and applies APSD to stop the output of the WDM light.

A configuration of the optical transmission apparatus 100B of the downstream (NodeB) is similar to that of the optical transmission apparatus 100A of the upstream (NodeA) described above, and the same constituent elements are denoted by the same reference signs.

Although FIG. 1 illustrates a configuration example of backward Raman pumping using the Raman amplifier 111, a configuration example of forward Raman pumping or forward Raman pumping and backward Raman pumping may be used.

The optical transmission apparatus 100A according to the embodiment executes an activation sequence of the following 1. to 4. at the time of activation (at the time of starting a span between a pair of optical transmission apparatuses 100A and 100B).

1. The optical transmission apparatus 100A measures (detects) a level (a first reflected light level, a reflection monitor value A) of reflected light of an OSC in a case where only OSC light is output as signal light to the downlink transmission line 101a.

2. Next, the optical transmission apparatus 100A measures a level (a second reflected light level, a reflection monitor value B) of the reflected light of the OSC in a case where OSC light, WDM light (C+L), and Raman pumping light by the Raman amplifier 111 are output as the signal light to the downlink transmission line 101a. In the case of the configuration example illustrated in FIG. 1, the Raman pumping light is backward pumped by the Raman amplifier 111 of the optical transmission apparatus 100B.

3. Next, the optical transmission apparatus 100A calculates a correction value for a reflection monitor value based on the measured reflection monitor values A and B. The optical transmission apparatus 100A calculates, for example, a difference between reflection levels when calculated by correction value for reflection monitor value=reflection monitor value B-reflection monitor value A. Although details will be described later, the correction value is equivalent to noise at the time of reflected light detection.

4. After that, the optical transmission apparatus 100A monitors the reflection monitor value during operation. At the time of monitoring by a reflection monitor, the optical transmission apparatus 100A corrects the reflection monitor value measured during operation by using the calculated correction value. For example, the reflection monitor value is calculated by reflection monitor value-correction value.

During the monitoring of the reflection monitor value, the optical transmission apparatus 100A compares the corrected reflection monitor value with a predetermined reflection detection threshold, and determines whether or not there is a failure (such as disconnection or opening of a transmission line) in the downlink transmission line 101a based on the corrected reflection monitor value. For example, in a case of high reflection (high level) in which the corrected reflection monitor value exceeds the reflection detection threshold, it is determined that a failure has occurred in the downlink transmission line 101a, and the optical amplifier 123a and the Raman amplifier 111 are shut down by applying APSD.

For example, in a case where fiber characteristics (loss, fiber type, and the like) in the transmission line 101a change, an optical fiber removal work occurs. Due to the occurrence of this removal work, APSD is applied, and the optical transmission apparatus 100A shuts down the optical amplifier 123a. In this case, after the optical fiber of the transmission line 101a is recoupled, the optical transmission apparatus 100A executes the processing of 1. to 4. described above again.

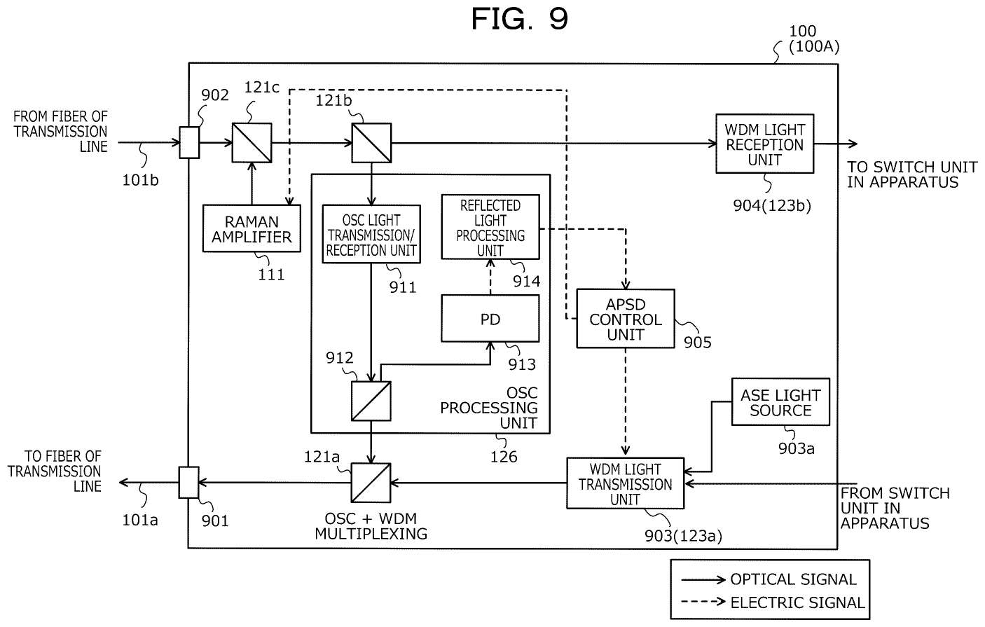

According to the above description, the processing of 1. to 4. described above is executed by the optical transmission apparatus 100A. For example, the processing of 1. to 3. described above is executed by the OSC processing unit 126 at the time of activation, and the processing of the above 4. is monitored and executed by an APSD control unit 905 (see FIG. 9) described later while the optical transmission apparatus 100A is in operation.

According to the optical transmission apparatus according to the embodiment, the correction value for the reflection monitor value is calculated at the time of activation, and the reflection monitor value is monitored by using the calculated correction value during operation. Accordingly, it is possible to suppress erroneous detection of reflected light due to noise light occurring in an OSM wavelength band by WDM transmission of wide-band multiband transmission.

For example, in a case where the reflection monitor value due to the noise light is erroneously detected, it is possible to suppress that APSD is applied and the WDM light (main signal) is cut off although no failure has occurred in the transmission line 101a. By suppressing the erroneous detection of the reflected light, APSD may be appropriately applied in a case where a failure (such as disconnection or opening of a transmission line) of the transmission line occurs, and reliability of a safety control function of the output light cutoff may be improved.

“Applying (operating)” APSD refers to control of “performing” output cutoff of the WDM light by APSD. “Not applying” APSD refers to control of “not performing” output cutoff of the WDM light by APSD.

### (Problem of Existing Technique)

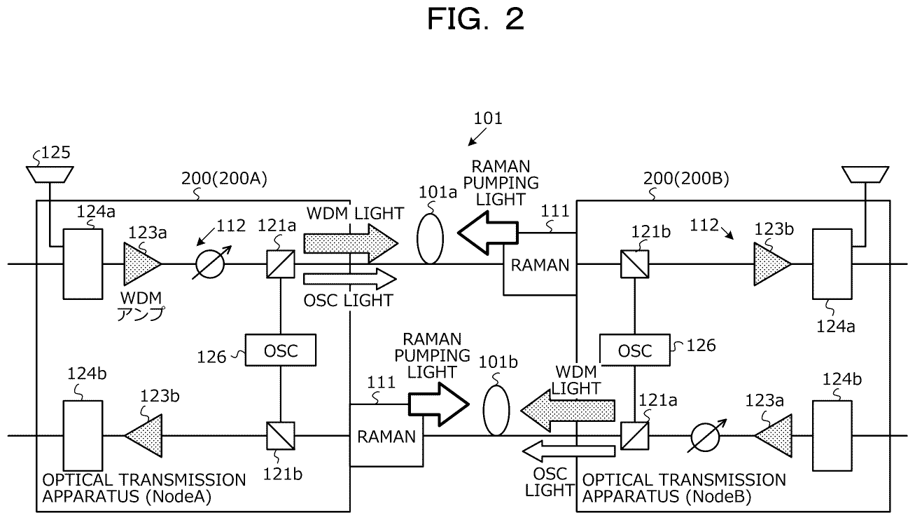

An expected operation and a problem of APSD according to the existing technique will be described with reference to FIGS. 2 to 7.

FIG. 2 is an explanatory diagram in a normal state according to the existing technique. For convenience, respective constituent elements of an existing optical transmission apparatus 200 illustrated in FIG. 2 and the like are denoted by the same reference signs as those of the optical transmission apparatus 100 according to the embodiment described with reference to FIG. 1. As illustrated in FIG. 2, in the normal state, an optical transmission apparatus 200A outputs WDM light and OSC light due to backward pumping of the transmission line 101a. The optical transmission apparatus 200A outputs the OSC light to the transmission line 101a.

As in the case of the optical transmission apparatus 200A, an optical transmission apparatus 200B performs the output of the WDM light and the OSC light to the transmission line 101b and APSD control.

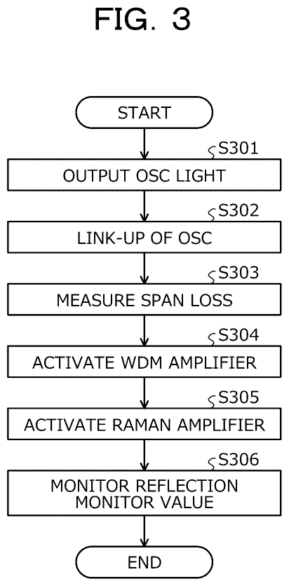

FIG. 3 is an activation sequence diagram of the optical transmission apparatus according to the existing technique. At the time of activation, in the optical transmission apparatus 200A, first, the OSC processing unit 126 outputs OSC light to the transmission line 101a (step S301), and checks link-up of an OSC (step S302).

Next, the optical transmission apparatus 200A measures a span loss of the transmission line 101a between the optical transmission apparatus 200A and the downstream optical transmission apparatus 200B (step S303). Next, the optical transmission apparatus 200A activates the WDM amplifier (optical amplifier) 123a (step S304), and activates the Raman amplifier 111 (step S305).

After that, the optical transmission apparatus 200A monitors the reflection monitor value during operation (step S306). For example, the optical transmission apparatus 200A determines whether or not there is a failure (such as disconnection or opening of a transmission line) in the downlink transmission line 101a based on a reflection monitor value of the downlink transmission line 101a. For example, when the reflection monitor value exceeds a predetermined reflection detection threshold, it is determined that a failure (fiber disconnection or opening) has occurred in the downlink transmission line 101a, and the optical amplifier 123a and the Raman amplifier 111 are shut down by applying APSD.

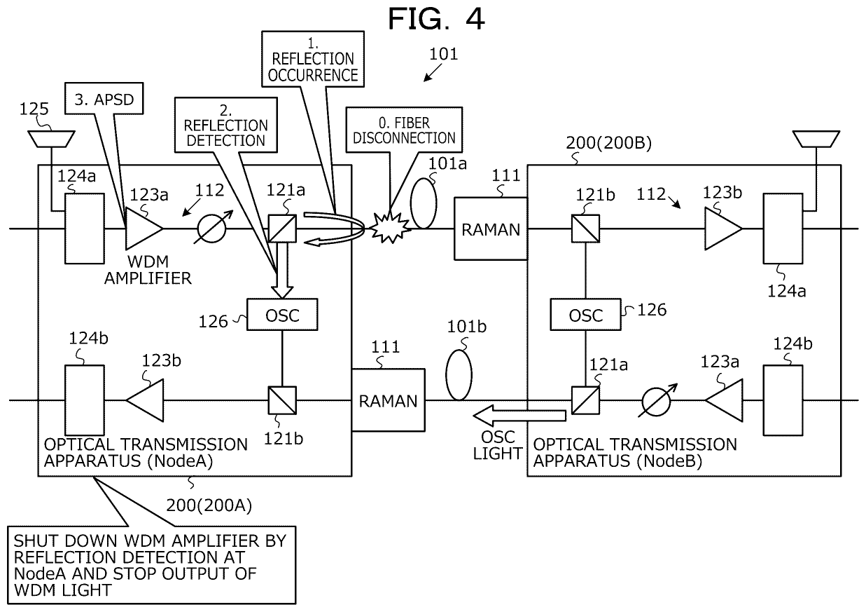

FIG. 4 is an explanatory diagram of an APSD state expected at the time of occurrence of a failure. As illustrated in FIG. 4, different from the normal state (refer to FIG. 2), it is assumed that a failure of 0. fiber disconnection occurs in the transmission line 101a. In this case, based on the fiber disconnection, 1. light reflection occurs over the transmission line 101a, and 2. the OSC processing unit 126 of the optical transmission apparatus 200A detects the reflection of the OSC light.

When a reflection monitor value of the OSC light exceeds a reflection detection threshold, the optical transmission apparatus 200A applies 3. APSD. Accordingly, the optical amplifier 123a is shut down, and the output of the WDM light to the transmission line 101a is stopped.

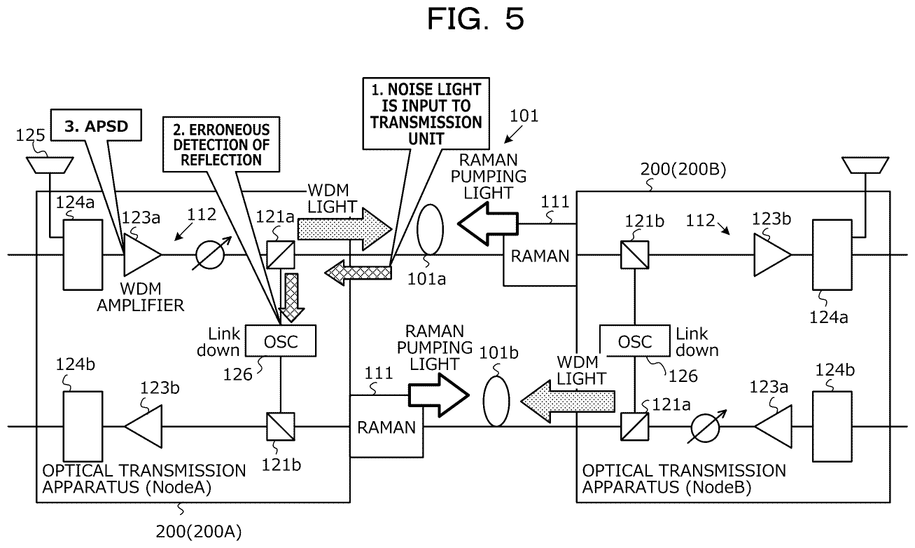

FIG. 5 is an explanatory diagram of a problem at the time of multiband transmission according to the existing technique. In a case where optical transmission using multiband WDM light such as a C+L band in the existing technique is performed, 1. noise light is input to a transmission unit of the optical transmission apparatus 200A at a high reflection level even in a state where no failure has occurred in the transmission line 101a. In this case, 2. the OSC processing unit 126 erroneously detects a reflection monitor value, and 3. APSD is applied.

Accordingly, in the existing technique, the optical transmission apparatus 200A may apply APSD due to, as a factor, noise light occurring in the transmission line 101a. In this case, even in a state where no failure has occurred in the transmission line 101a, the optical amplifier 123a is shut down by the APSD, and the output of the WDM light to the transmission line 101a is stopped (linked-down).

As described above, in a case where multiband transmission in recent years is attempted with the optical transmission apparatus 200A of the existing technique, the light power of the WDM light causes noise to occur in an OSC wavelength band, and reflected light of the noise light may be erroneously detected.

For example, in the multiband transmission, the Raman amplifier 111 that performs the backward Raman pumping or the forward Raman pumping described above outputs pumping light of Raman wavelengths (primary pumping light and secondary pumping light) in a predetermined band corresponding to the C+L band to the transmission line 101a. A gain is generated in the band of the C+L WDM light over the transmission line 101a by the pumping light. However, wide-band WDM light by the C+L affects the OSC wavelength band.

The optical transmission apparatus 200A has an ASE light source for the WDM transmission, and the number of wavelengths of the WDM light to be output is kept stable at all times. For example, the optical transmission apparatus 200A automatically adds ASE light into an empty wavelength for which service operation is not performed. ASE is an abbreviation for amplified spontaneous emission.

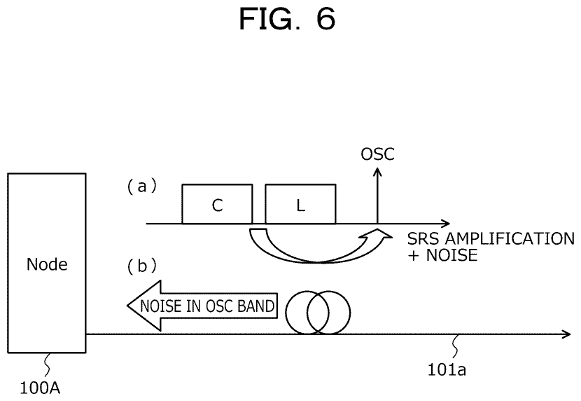

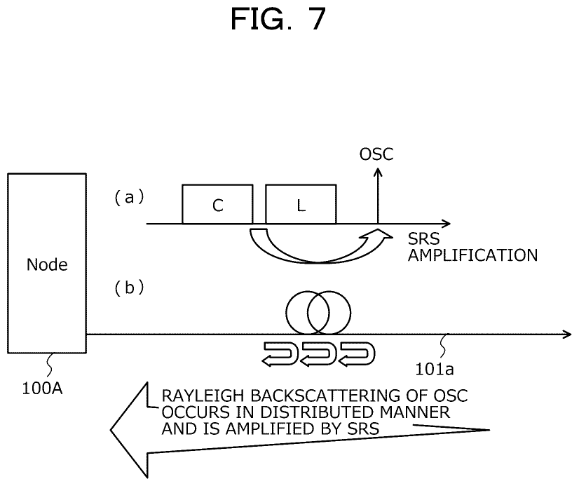

Next, the noise light occurrence in the multiband transmission will be described with reference to FIGS. 6 and 7. Horizontal axes in (a) in FIG. 6 and (a) in FIG. 7 indicate a wavelength, and horizontal axes in (b) in FIG. 6 and (b) in FIG. 7 indicate a longitudinal direction of the transmission line 101a.

FIG. 6 is an explanatory diagram of a factor 1 of the noise light occurrence. As illustrated in (a) in FIG. 6, wide-band C+L band WDM light having a gain generates noise in the OSC wavelength band along with SRS amplification. As illustrated in (b) in FIG. 6, the noise in the OSC wavelength band that has become highly reflective (high level) is reflected and input from the transmission line 101a to the transmission node (optical transmission apparatus 100A).

FIG. 7 is an explanatory diagram of a factor 2 of the noise light occurrence. As illustrated in (a) FIG. 7, the wide-band C+L band WDM light having a gain generates noise in the OSC wavelength band along with SRS amplification. As illustrated in (b) in FIG. 7, since the light power of the OSC light is increased by the SRS, Rayleigh backscattering itself occurs in a distributed manner and increased, and the Rayleigh backscattering amplified by the SRS is reflected and input from the transmission line 101a to the transmission node (optical transmission apparatus 200A).

For the problems described above, in the optical transmission apparatus 100 (100A) according to the embodiment, as described above, the correction value for the reflection monitor value is calculated at the time of activation, and the reflection monitor value is monitored by using the calculated correction value during operation. Accordingly, it is possible to suppress erroneous detection of reflected light due to noise light occurring in the OSM wavelength band by WDM transmission of wide-band multiband transmission. By suppressing the erroneous detection of the reflected light, in a case where a failure of a transmission line (such as disconnection or opening of a transmission line) occurs, APSD is applied to improve reliability of a safety control function of output light cutoff.

### (APSD Control by Correction of Reflection Monitor Value in Embodiment)

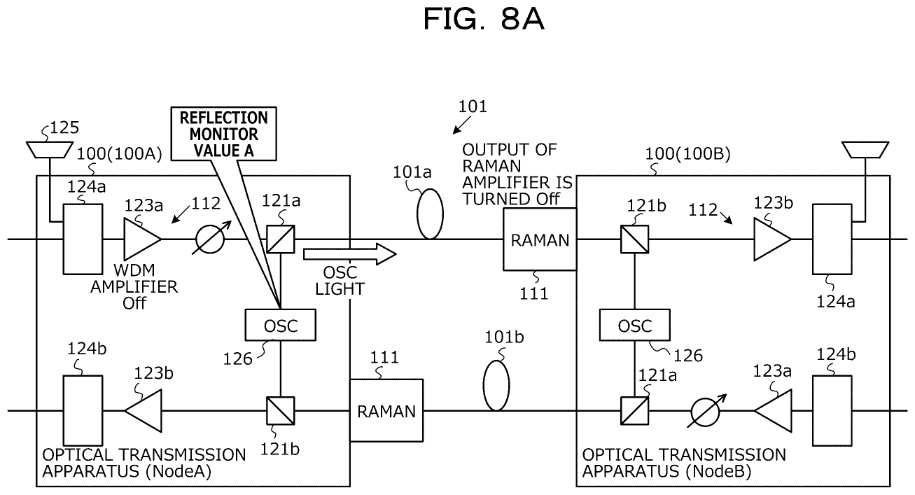

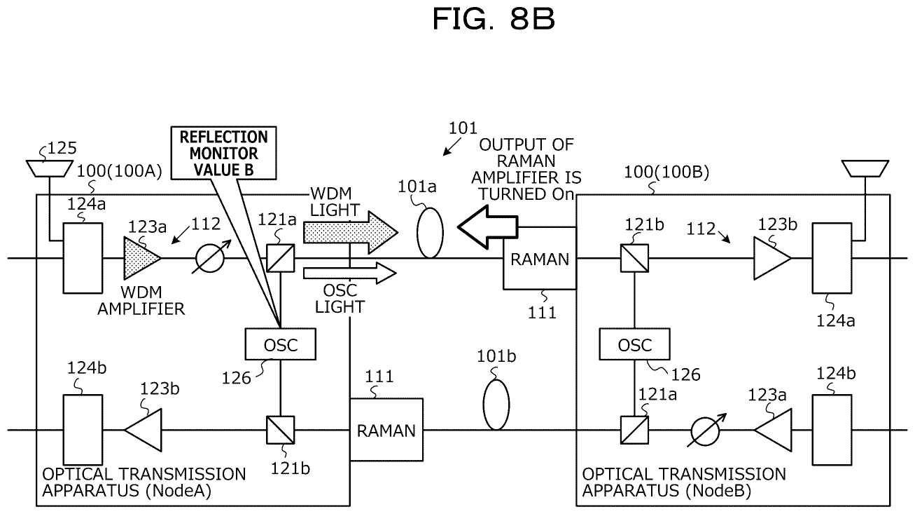

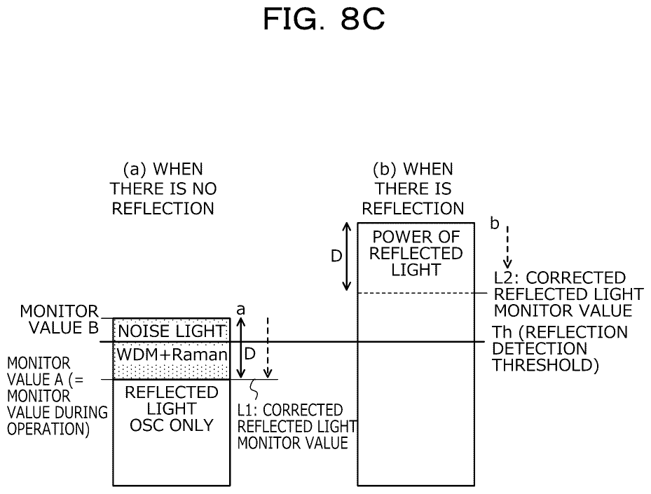

FIGS. 8A and 8B are explanatory diagrams of correction of the reflection monitor value in the optical transmission apparatus according to the embodiment. At the time of activation (at the time of starting a span between a pair of optical transmission apparatuses 100A and 100B), the optical transmission apparatus 100A executes an activation sequence of the following 1. to 4.

1. The optical transmission apparatus 100A measures (detects) a level (a reflection monitor value A) of reflected light of an OSC in a case where only OSC light is output as signal light to the transmission line 101a in a state where output of Raman pumping (the Raman amplifier 111) for the downlink transmission line 101a is turned off (see FIG. 8A).

For example, in a state where the output of the Raman amplifier 111 of the optical transmission apparatus 100B is turned off, in the optical transmission apparatus 100A, the OSC processing unit 126 outputs OSC light to the downlink transmission line 101a, and detects the reflection monitor value A of the OSC light from the downlink transmission line 101a.

2. Next, the optical transmission apparatus 100A measures a level (a reflection monitor value B) of the reflected light of the OSC in a case where OSC light, WDM light (C+L), and Raman pumping light by the Raman amplifier 111 are output as the signal light to the downlink transmission line 101a (see FIG. 8B).

For example, the output of the Raman amplifier 111 of the optical transmission apparatus 100B is turned on to backward pump the transmission line 101a. Alternatively, the Raman pumping for the transmission line 101a may be configured by forward Raman pumping provided at an output end of the transmission line 101a of the optical transmission apparatus 100A or by a combination of forward Raman pumping and backward Raman pumping.

3. Next, the optical transmission apparatus 100A calculates a correction value for a reflection monitor value based on the measured reflection monitor values A and B. For example, the optical transmission apparatus 100A calculates correction value for reflection monitor value=reflection monitor value B−reflection monitor value A (unit: dB). The correction value is equivalent to noise at the time of reflected light detection.

4. After that, the optical transmission apparatus 100A monitors the reflection monitor value during operation. At the time of monitoring by a reflection monitor, the optical transmission apparatus 100A corrects the reflection monitor value by using the calculated correction value. For example, the correction is performed by reflection monitor value=reflected light measurement value-correction value (unit: dB).

During the monitoring of the reflection monitor value, the optical transmission apparatus 100A compares the corrected reflection monitor value with a predetermined reflection detection threshold, and determines whether or not there is a failure (such as disconnection or opening of a transmission line) in the downlink transmission line 101a based on the corrected reflection monitor value. For example, in a case where the corrected reflection monitor value exceeds the reflection detection threshold, it is determined that a failure has occurred in the downlink transmission line 101a, and the optical amplifier 123a and the Raman amplifier 111 are shut down by applying APSD.

For example, in a case where fiber characteristics (loss, fiber type, and the like) in the transmission line 101a change, an optical fiber removal work occurs. Due to the occurrence of this removal work, APSD is applied, and the optical transmission apparatus 100A shuts down the optical amplifier 123a. In this case, after the optical fiber of the transmission line 101a is recoupled, the optical transmission apparatus 100A executes the processing of 1. to 4. described above again.

FIG. 8C is a chart for describing the correction of the reflection monitor value and the APSD control according to the embodiment. (a) in FIG. 8C illustrates a reflection monitor value when there is no reflection (there is no failure), and (b) in FIG. 8C illustrates a reflection monitor value when there is reflection (there is a failure). A vertical axis indicates a level of reflected light.

As illustrated in (a) in FIG. 8C, the reflection monitor value A is equivalent to a reflection monitor value in a case where only OSC light is output illustrated in FIG. 8A, and a reflection monitor value B is equivalent to a reflection monitor value due to OSC light, WDM light, and Raman pumping light illustrated in FIG. 8B.

Reflection monitor value B-reflection monitor value A (difference D) is a level of noise light, and is a correction value for the reflection monitor value illustrated in (a) in FIG. 8C. The optical transmission apparatus 100A sets a reflection detection threshold Th to, for example, a substantially median value of the reflection monitor value B and the reflection monitor value A.

The optical transmission apparatus 100A sets and holds the reflection detection threshold Th, monitors the level of the reflected light of the OSC light, and performs APSD control by comparing the level of the reflected light of the OSC light with the reflection detection threshold Th.

For example, a reflection monitor value a detected when there is no reflection illustrated in (a) in FIG. 8C decreases in level by the correction value (difference D), and becomes a corrected reflection monitor value L1. The corrected reflection monitor value L1 has a level equivalent to the reflection monitor value A and is lower than the reflection detection threshold Th. Accordingly, the optical transmission apparatus 100A may appropriately determine that there is no reflection (there is no failure) based on the corrected reflection monitor value L1.

In a case where the operation is performed without correction, since the reflection monitor value a exceeds the reflection detection threshold Th, it is erroneously determined that there is reflection (there is a failure) and the reflected light.

When there is reflection illustrated in (b) in FIG. 8C, a corrected reflection monitor value L2 is obtained. The corrected reflection monitor value L2 is a level of actually detected reflection monitor value b-correction value (difference D). The reflection monitor value L2 in the case of (b) in FIG. 8C exceeds the reflection detection threshold Th. In this case, the optical transmission apparatus 100A may appropriately determine that there is reflection (there is a failure) based on the corrected reflection monitor value L2. The APSD control based on the presence or absence of an occurrence of a failure may be appropriately performed.

(Functional Configuration Example of Optical Transmission Apparatus)

FIG. 9 is a functional block diagram of the optical transmission apparatus according to the embodiment. In FIG. 9, constituent elements that are the same as the constituent elements of the optical transmission apparatus 100 (100A) in FIG. 1 and the like described above are denoted by the same reference signs. Solid lines in FIG. 9 indicate optical signals and dotted lines indicate electric signals.

FIG. 9 mainly illustrates a configuration in which reflected light from the transmission line 101a is detected and APSD control is performed based on a corrected reflection monitor value in the optical transmission apparatus 100 described above.

The optical transmission apparatus 100 includes individual functions of a transmission port 901, a reception port 902, the Raman amplifier 111, the multiplexers/demultiplexers 121, the OSC processing unit 126, a WDM light transmission unit 903, a WDM light reception unit 904, and the APSD control unit 905.

The Raman amplifier 111 outputs pumping light for backward pumping to the transmission line 101b via a multiplexer/demultiplexer 121c.

The WDM light transmission unit 903 is equivalent to the optical amplifier 123a, and transmits and outputs transmission data output from a switch unit (WSS 124) in the apparatus to the transmission line 101a as WDM light by using ASE light output from an ASE light source 903a.

The OSC processing unit 126 multiplexes OSC light transmitted by an OSC light transmission/reception unit 911 with the WDM light via an optical filter 912 and the multiplexer/demultiplexer 121a, and outputs the multiplexed light to the transmission line 101a. The multiplexer/demultiplexer 121a multiplexes the OSC light with the WDM light output from the WDM light transmission unit 903. The optical filter 912 passes only a wavelength band of the OSC light.

The WDM light including the OSC light transmitted from the downstream node (optical transmission apparatus 100B) and input via the transmission line 101b is demultiplexed into OSC light by the multiplexer/demultiplexer 121b and received by the OSC light transmission/reception unit 911.

Among the WDM light including the OSC light to be output to the transmission line 101b, a wavelength band of the OSC light is extracted from optical components to be reflected and input via the multiplexer/demultiplexer 121a to the optical filter 912, and optical components are detected by a photodetector (PD) 913.

At the time of execution of the activation sequence of 1. to 4. described above, a reflected light processing unit 914 executes processing related to 1. measurement of a reflection monitor value A, 2. measurement of a reflection monitor value B, and 3. calculation of a correction value for a reflection monitor value.

As for the 1. reflection monitor value A, in a state where only the OSC light is output as signal light to the downlink transmission line 101a, the reflected light processing unit 914 measures a reflection level of the OSC light detected by the PD 913 as the reflection monitor value A via the transmission line 101a, the multiplexer/demultiplexer 121a, and the optical filter 912.

The reflected light processing unit 914 measures the 2. reflection monitor value B in the same manner. In this case, in a state where the OSC light, the WDM light (C+L), and the Raman pumping light are output as the signal light to the downlink transmission line 101a, the reflected light processing unit 914 measures the reflection level of the OSC light detected by the PD 913 as the reflection monitor value B via the transmission line 101a, the multiplexer/demultiplexer 121a, and the optical filter 912.

As illustrated in FIG. 8C and the like, the reflected light processing unit 914 calculates the 3. correction value for the reflection monitor value based on the reflection monitor values A and B, and outputs the calculated correction value for the reflection monitor value to the APSD control unit 905.

Accordingly, the APSD control unit 905 corrects the reflection monitor value based on the calculated correction value, and monitors the 4. reflection monitor value during operation. For example, when a failure occurs in the transmission line 101a, the APSD control unit 905 cuts off the output light to the transmission line 101a by the WDM light transmission unit 903 (optical amplifier 123a) and cuts off the Raman pumping to the transmission line 101b by the Raman amplifier 111 when the APSD control is performed.

Besides, when a failure occurs in the transmission line 101a, the APSD control unit 905 notifies the OSC processing unit 126 of an APSD request to the downstream NodeB (100B) by using an OSC signal.

### (Hardware Configuration Example of Control Unit of Optical Transmission Apparatus)

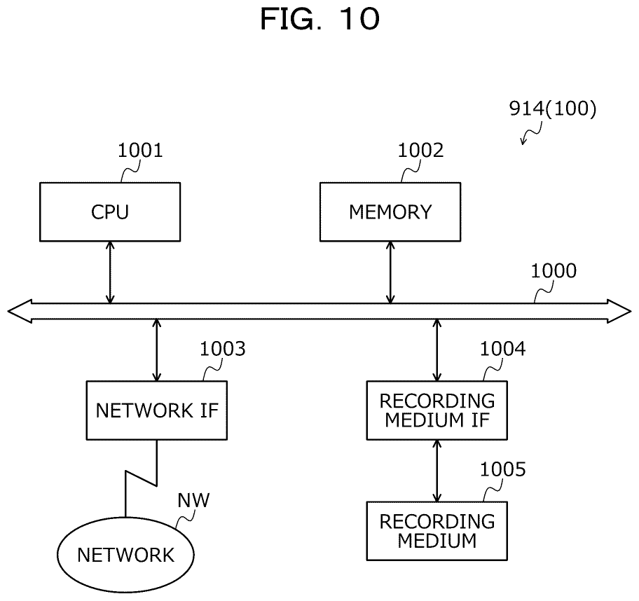

FIG. 10 is a diagram illustrating a hardware configuration example of a control unit of the optical transmission apparatus according to the embodiment. For example, the function related to the reflected light processing unit 914 illustrated in FIG. 9 may be configured by general-purpose hardware illustrated in FIG. 10.

The APSD control unit 905 illustrated in FIG. 9 is desired to perform high-speed processing, and is currently configured by hardware such as a field-programmable gate array (FPGA).

An example illustrated in FIG. 10 has a processor 1001 such as a central processing unit (CPU), a memory 1002, a network interface (IF) 1003, a recording medium IF 1004, and a recording medium 1005. The respective constituent elements are coupled to each other by a bus 1000.

The processor 1001 is a control unit that mainly controls the function related to the reflected light processing unit 914. The processor 1001 may have a plurality of cores. The memory 1002 has, for example, a read-only memory (ROM), a random-access memory (RAM), a flash ROM, and the like. For example, the flash ROM stores a control program, the ROM stores an application program, and the RAM is used as a work area of the processor 1001. The program stored in the memory 1002 causes the processor 1001 to execute coded processing by being loaded into the processor 1001.

The network IF 1003 serves as an interface with a network NW and controls input and output of information to and from the outside. For example, the network NW is not limited to a wired or wireless electric transmission line, and an optical transmission line via the transmission line 101 may be used.

According to the control of the processor 1001, the recording medium IF 1004 controls read and write of data from and to the recording medium 1005. The recording medium 1005 stores the data written under the control of the recording medium IF 1004.

Besides the constituent elements described above, for example, an input device, a display, and the like may be coupled via an IF.

The function of the control unit illustrated in FIG. 10 may be, for example, a control unit that performs overall control on the optical transmission apparatus 100. In this case, the function of the reflected light processing unit 914 illustrated in FIG. 9 may be a partial function of the control unit (processor 1001) that performs overall control on the optical transmission apparatus 100.

### (Processing Example of Reflected Light Control)

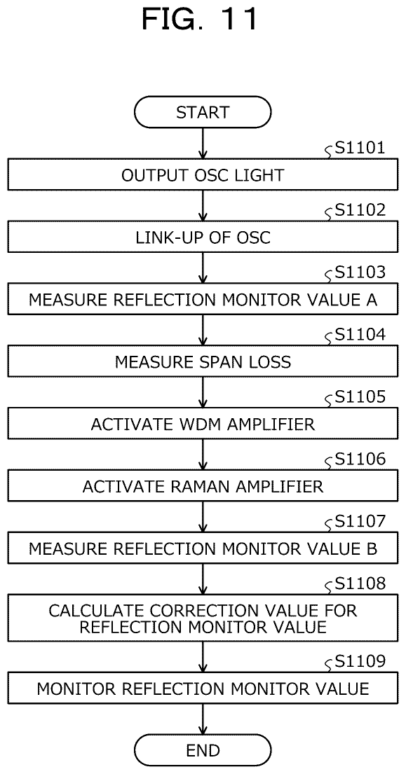

FIG. 11 is an activation sequence diagram of the optical transmission apparatus according to the embodiment. FIG. 11 illustrates an activation sequence in a normal state, and illustrates processing executed by the control unit of the optical transmission apparatus 100 (100A), mainly the reflected light processing unit 914 (processor 1001 in FIG. 10).

At the time of activation, in the optical transmission apparatus 100A (reflected light processing unit 914), first, the OSC processing unit 126 outputs OSC light to the transmission line 101a (step S1101), and checks link-up of an OSC (step S1102).

Next, the optical transmission apparatus 100A measures a reflection monitor value A of the OSC light (step S1103). The optical transmission apparatus 100A measures a span loss of the transmission line 101a between the optical transmission apparatus 100A and the downstream optical transmission apparatus 100B (step S1104).

Next, the optical transmission apparatus 100A activates the WDM amplifier (optical amplifier) 123a (step S1105), and activates the Raman amplifier 111 (step S1106).

Next, the optical transmission apparatus 100A measures a reflection monitor value B of the OSC light (step S1107). Next, the optical transmission apparatus 100A calculates a correction value for a reflection monitor value based on the measured reflection monitor values A and B (step S1108). The calculated correction value for the reflection monitor value is held by the APSD control unit 905.

After that, the optical transmission apparatus 100A monitors the reflection monitor value during operation (step S1109). For example, the optical transmission apparatus 100A (APSD control unit 905) determines whether or not there is a failure (such as disconnection or opening of a transmission line) in the downlink transmission line 101a based on a reflection monitor value of the downlink transmission line 101a.

For example, when the corrected reflection monitor values (L1 and L2) exceed a predetermined reflection detection threshold Th, it is determined that a failure (fiber disconnection or opening) has occurred in the downlink transmission line 101a, and the optical amplifier 123a and the Raman amplifier 111 are shut down by applying APSD.

In the normal state illustrated in FIG. 11, since the optical transmission apparatus 100A keeps the number of wavelengths of the WDM stable at all times, the correction value for the reflection monitor value does not change even when the operation wavelengths by a ROADM function change. For example, the optical transmission apparatus 100A automatically adds ASE light into an empty wavelength for which service operation is not performed, and keeps the number of wavelengths of the WDM stable at all times.

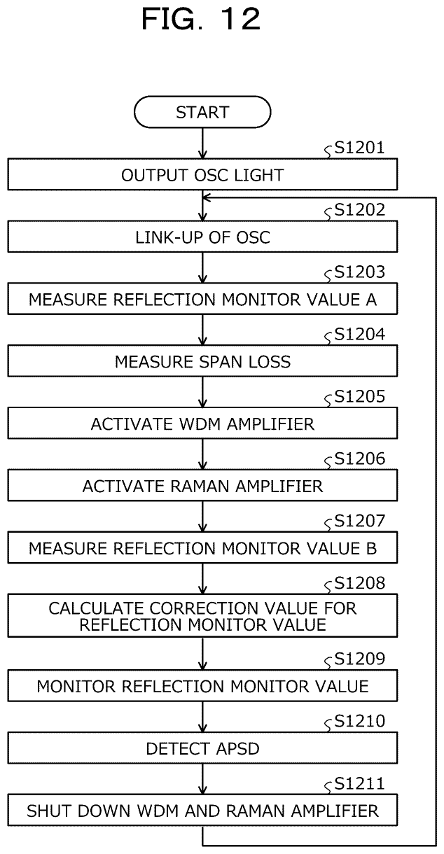

FIG. 12 is an activation sequence diagram of the optical transmission apparatus according to the embodiment. FIG. 12 illustrates processing executed by the control unit of the optical transmission apparatus 100 (100A), mainly the reflected light processing unit 914 (processor 1001 in FIG. 10), in a case where the fiber characteristics in the transmission line 101a are changed.

Due to the fiber removal work, the fiber characteristics (loss, fiber type, and the like) in the transmission line 101a change. By this fiber removal work, the optical transmission apparatus 100A applies APSD to shut down the WDM amplifier (optical amplifier 123a), and executes the sequence again after the recoupling of the fibers.

For example, as illustrated in FIG. 12, at the time of activation, in the optical transmission apparatus 100A (reflected light processing unit 914), first, the OSC processing unit 126 outputs OSC light to the transmission line 101a (step S1201), and checks link-up of an OSC (step S1202).

Next, the optical transmission apparatus 100A measures a reflection monitor value A of the OSC light (step S1203). The optical transmission apparatus 100A measures a span loss of the transmission line 101a between the optical transmission apparatus 100A and the downstream optical transmission apparatus 100B (step S1204).

Next, the optical transmission apparatus 100A activates the WDM amplifier (optical amplifier) 123a (step S1205), and activates the Raman amplifier 111 (step S1206).

Next, the optical transmission apparatus 100A measures a reflection monitor value B of the OSC light (step S1207). Next, the optical transmission apparatus 100A calculates a correction value for a reflection monitor value based on the measured reflection monitor values A and B (step S1208). The calculated correction value for the reflection monitor value is held by the APSD control unit 905.

After that, the optical transmission apparatus 100A monitors the reflection monitor value during operation (step S1209). For example, the optical transmission apparatus 100A (APSD control unit 905) determines whether or not there is a failure in the downlink transmission line 101a based on a reflection monitor value of the downlink transmission line 101a.

For example, the corrected reflection monitor value (L2) exceeds the predetermined reflection detection threshold Th due to the change in the fiber characteristics (loss, fiber type, and the like) described above, for example, due to the occurrence of the fiber removal work. Accordingly, the optical transmission apparatus 100A (APSD control unit 905) determines that a failure has occurred in the downlink transmission line 101a, and applies APSD (step S1210). The optical transmission apparatus 100A (APSD control unit 905) shuts down the optical amplifier 123a and the Raman amplifier 111 (step S1211). After the recoupling of the fibers, the optical transmission apparatus 100A returns to the processing in step S1202 and executes the activation sequence again.

According to the above-described embodiment, the optical transmission apparatus 100A of the transmission node (NodeA) in one span executes the processing of 1. to 4. described above. Without being limited to this, the present disclosure may also be applied to an optical transmission system having a plurality N of optical transmission apparatuses 100A to 100N having a plurality of spans and a network management device (for example, a network controller).

For example, the optical transmission apparatus 100 of the transmission node (NodeA) in one corresponding span performs the processing of 1. “measurement of reflection monitor value A” and 2. “measurement of reflection monitor value B” described above. The network controller acquires information of 1, and 2. described above from the optical transmission apparatus 100 of the transmission node (NodeA) in the corresponding span, calculates 3. “corrected reflection monitor value”, and transmits the calculated corrected reflection monitor value to the optical transmission apparatus 100 of the transmission node (NodeA) in the corresponding span. 4. “Monitoring of reflection monitor value and APSD control” described above may be performed by using the corrected reflection monitor value by the optical transmission apparatus 100 of the transmission node (NodeA) in the corresponding span.

Although the C-band and the L-band have been described as examples of the multiband transmission of the WDM light in the above-described embodiment, the embodiment may be similarly applied to multiband transmission including a plurality of other bands in which Raman pumping light generates noise in a wavelength band of the OSC.

The optical transmission apparatus according to the embodiment described above performs Raman amplification on WDM light in a transmission line using Raman pumping light. The optical transmission apparatus includes a control unit, The control unit, at the time of activation of the optical transmission apparatus, measures a first reflected light level that is reflected and input from the transmission line when only OSC light is transmitted to the transmission line, and measures a second reflected light level that is reflected and input from the transmission line when the WDM light, the Raman pumping light, and the OSC light are transmitted to the transmission line. After that, the control unit calculates a correction value equivalent to noise light of a reflected light level that is reflected and input from the transmission line, based on the first reflected light level and the second reflected light level. The control unit, during operation of the optical transmission apparatus, monitors the input reflected light level and performs auto power shut down (APSD) control based on a reflected light level corrected by the correction value. Accordingly, since the reflected light level is monitored by correcting the noise light equivalent included in the reflected light from the transmission line, malfunction of APSD due to the noise included in the OSC light may be suppressed, and APSD control based on the presence or absence of occurrence of a failure may be appropriately performed.

In the embodiment, the WDM light of the optical transmission apparatus includes a plurality of bands in which the Raman pumping light generates noise in a wavelength band of the OSC. For example, the bands are a C-band and an L-band. Accordingly, it is possible to calculate an appropriate correction value even when high-level noise light is included in the reflected light due to the multiband transmission.

The optical transmission apparatus according to the embodiment includes a Raman pumping amplifier that outputs the Raman pumping light to the transmission line by backward pumping, forward pumping, or a combination of backward pumping and forward pumping. Accordingly, even when high-level noise light is included in the reflected light due to Raman pumping, it is possible to calculate an appropriate correction value.

The optical transmission apparatus according to the embodiment includes an optical filter that passes only a wavelength band of the OSC light among signal light reflected and input from the transmission line, and a photodetector that detects a reflected light level of the OSC light that has passed through the optical filter, and the control unit monitors the reflected light level detected by the photodetector. Accordingly, a level of the noise light included in the OSC light may be detected, the reflected light level may be monitored by correcting the noise light equivalent, and the APSD control may be appropriately performed in accordance with the presence or absence of the occurrence of the failure.

In the embodiment, the control unit of the optical transmission apparatus calculates the correction value for the reflected light level based on a difference between the first reflected light level and the second reflected light level, sets a reflection detection threshold based on the correction value for the reflected light level, and during operation, compares the input reflected light level with the reflection detection threshold and performs the APSD control based on a result of the comparison. As described above, the optical transmission apparatus may calculate the correction value for the reflected light level by simple calculation processing, and may easily and appropriately perform the APSD control by using the reflection detection threshold based on the correction value for the reflected light level at the time of monitoring.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission apparatus that performs Raman amplification on WDM light in a transmission line using Raman pumping light, the optical transmission apparatus comprising:
a controller configured to
at a time of activation of the optical transmission apparatus, measure a first reflected light level that is reflected and input from the transmission line when only optical supervisory channel (OSC) light is transmitted to the transmission line,
measure a second reflected light level that is reflected and input from the transmission line when the WDM light, the Raman pumping light, and the OSC light are transmitted to the transmission line,
calculate a correction value equivalent to noise light of a reflected light level that is reflected and input from the transmission line, based on the first reflected light level and the second reflected light level, and
during operation of the optical transmission apparatus, monitor the input reflected light level and perform auto power shut down (APSD) control based on a reflected light level corrected by the correction value.

2. The optical transmission apparatus according to claim 1, wherein the WDM light includes a plurality of bands in which the Raman pumping light generates noise in a wavelength band of the OSC.

3. The optical transmission apparatus according to claim 2, wherein the bands are a C-band and an L-band.

4. The optical transmission apparatus according to claim 1, further comprising a Raman pumping amplifier configured to output the Raman pumping light to the transmission line by backward pumping, forward pumping, or a combination of backward pumping and forward pumping.

5. The optical transmission apparatus according to claim 1, further comprising:
an optical filter configured to pass only a wavelength band of the OSC light among signal light reflected and input from the transmission line; and
a photodetector configured to detect a reflected light level of the OSC light that has passed through the optical filter, wherein
the control unit monitors the reflected light level detected by the photodetector.

6. The optical transmission apparatus according to claim 1,
wherein the control unit is further configured to
calculate the correction value for the reflected light level based on a difference between the first reflected light level and the second reflected light level,
set a reflection detection threshold based on the correction value for the reflected light level, and
during the operation, compare the input reflected light level with the reflection detection threshold and perform the APSD control based on a result of the comparison.

7. The optical transmission apparatus according to claim 1, wherein
the control unit is further configured to
during the operation, in a case where the WDM light to the transmission line is stopped by the APSD control, execute processing at the time of activation again.

8. An optical transmission method implemented by an optical transmission apparatus that performs Raman amplification on WDM light in a transmission line using Raman pumping light, the optical transmission method comprising:
at a time of activation of the optical transmission apparatus, measuring a first reflected light level that is reflected and input from the transmission line when only optical supervisory channel (OSC) light is transmitted to the transmission line,
measuring a second reflected light level that is reflected and input from the transmission line when the WDM light, the Raman pumping light, and the OSC light are transmitted to the transmission line,
calculating a correction value equivalent to noise light of a reflected light level that is reflected and input from the transmission line, based on the first reflected light level and the second reflected light level, and
during operation of the optical transmission apparatus, monitoring the input reflected light level and perform auto power shut down (APSD) control based on a reflected light level corrected by the correction value.
